(19) United States
(12) Patent Application Publication
(10) Pub. No.: US 2013/0146168 A1
(43) Pub. Date: Jun. 13, 2013

(54) Pipe Leak Repair Assembly and Method

(71) Applicant: Mohammed H. Ammouri, Pottstown, PA (US)

(72) Inventor: Mohammed H. Ammouri, Pottstown, PA (US)

(21) Appl. No.: 13/314,368

(22) Filed: Dec. 8, 2011

(51) Int. Cl. F16L 55/16

(52) U.S. Cl. 138/98

(57) ABSTRACT

A pipe leak repair assembly and method for includes a pipe having an aperture therein. The pipe has a tubular shape and is comprised of a plastic material. The pipe has circular cross-section. A covering comprising an annular member has a break therein such that a first end and a second end are defined. The covering is comprised of a resiliently bendable material. The covering is configured to allow the first and second ends to be spaced apart to form a pipe receiving space. The pipe is extended through the pipe receiving space so that the covering abuts the covering and the covering is positioned over the aperture. An adhesive adhere the covering to the pipe to prevent movement of the covering with respect to the pipe.

### BACKGROUND OF THE DISCLOSURE

### Field of the Disclosure

The disclosure relates to leak repairing devices and more particularly pertains to a new leak repairing device for covering and sealing a leak in a pipe.

### SUMMARY OF THE DISCLOSURE

An embodiment of the disclosure meets the needs presented above by generally comprising a pipe having an aperture therein. The pipe has a tubular shape and is comprised of a plastic material. The pipe has circular cross-section. A covering comprising an annular member has a break therein such that a first end and a second end are defined. The covering is comprised of a resiliently bendable material. The covering is configured to allow the first and second ends to be spaced apart to form a pipe receiving space. The pipe is extended through the pipe receiving space so that the covering abuts the covering and the covering is positioned over the aperture. An adhesive adhere the covering to the pipe to prevent movement of the covering with respect to the pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a side view of a covering of a pipe leak repair assembly and method according to an embodiment of the disclosure.

FIG. 2 is a front view of an embodiment of the disclosure.

FIG. 3 is a perspective view of an embodiment of the disclosure.

FIG. 4 is a perspective view of an embodiment of the disclosure.

FIG. 5a is a cross-sectional view of an embodiment of the disclosure.

FIG. 5b is a cross-sectional view of an embodiment of the disclosure taken along line 5-5 of FIG. 4.

### DESCRIPTION OF THE PREFERRED EMBODIMENT

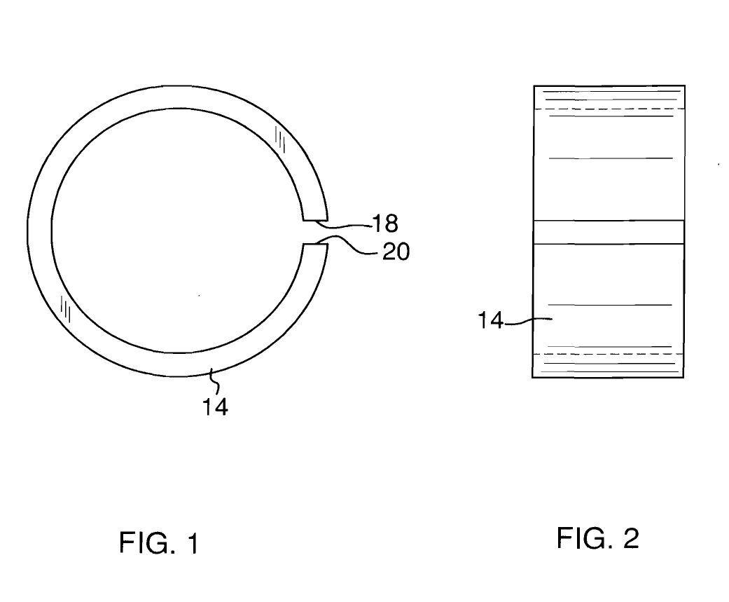

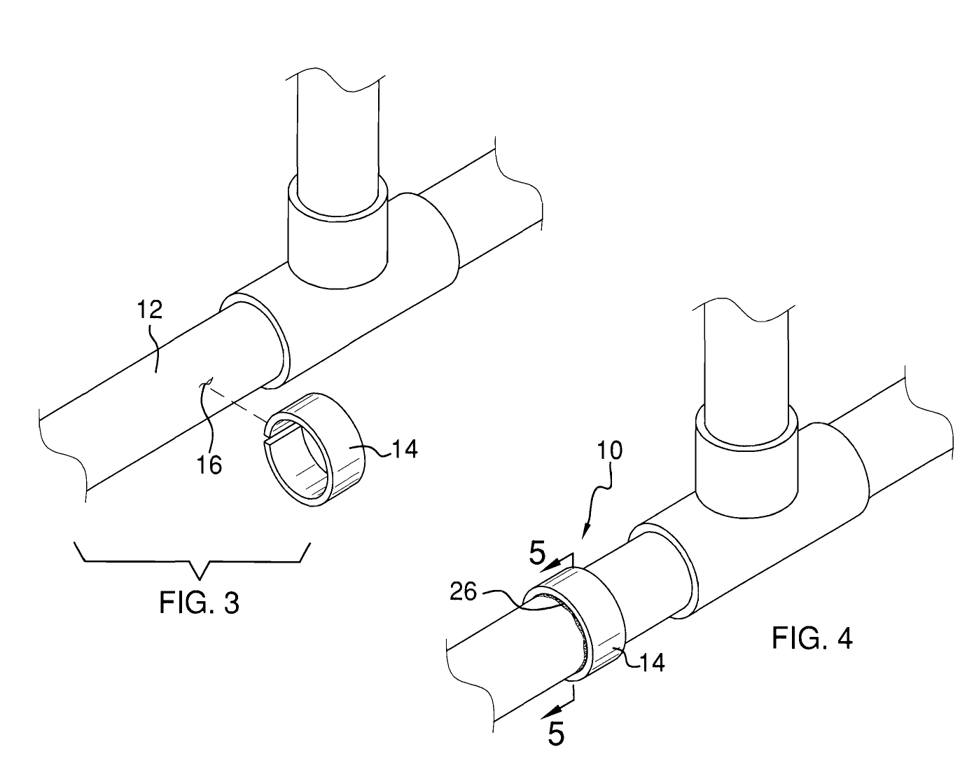

With reference now to the drawings, and in particular to FIGS. 1 through 5 thereof, a new leak repairing device embodying the principles and concepts of an embodiment of the disclosure and generally designated by the reference numeral 10 will be described.

As best illustrated in FIGS. 1 through 5, the pipe leak repair assembly 10 and method generally comprises positioning a covering 12 on a pipe 14 that has an aperture 16 therein and covering the aperture 16 with the covering 12. The pipe 12 is a conventional fluid conduit that has a tubular shape and will likely be comprised of a plastic material. In particular the pipe 12 will be comprised of polyvinylchloride or as typically called a pvc pipe. The pipe 12 has circular cross-section. The aperture 16 may include a crack in the pipe 12 or may include a hole such as may be made accidentally by a drill or fastener being driven through a wall adjacent to the pipe 12.

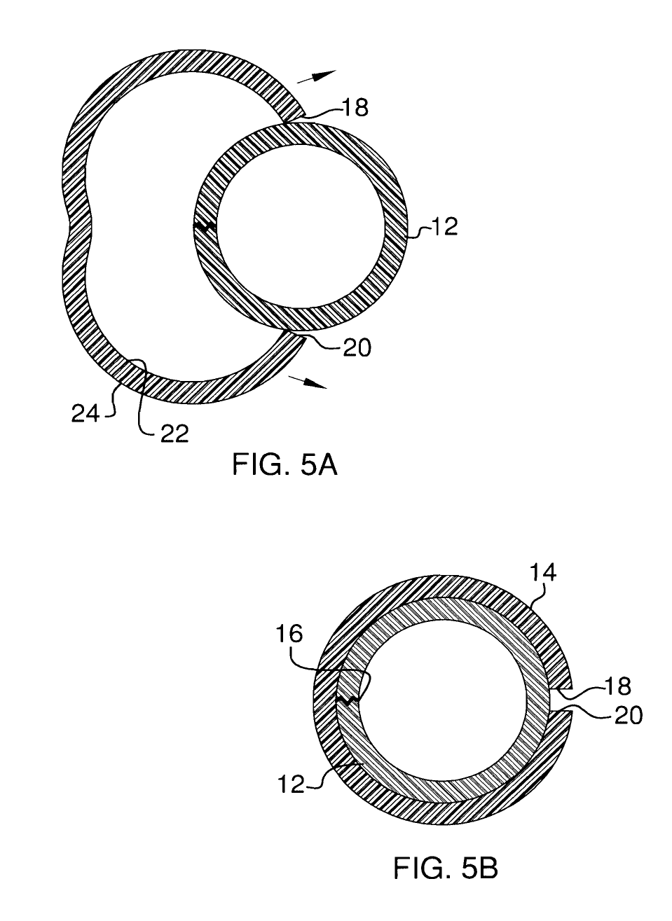

The covering 14 comprises an annular member that has a break therein such that a first end 18 and a second end 20 are defined. The covering 14 is comprised of a resiliently bendable material which may include a plastic or an elastomer. The covering 14 has an inner surface 22 and an outer surface 24 such that a width of the covering 14 is defined from the inner surface 22 to the outer surface 24. The width of the covering 14 is at least 30% of the outer diameter of the pipe and may be up to 60% of the diameter. For most usages, the width will be between 40% and 55% of the diameter to ensure structural integrity of the covering 14. The method includes spacing apart the first 18 and second 20 ends to form a pipe receiving space between the first 18 and second 20 ends to allow the pipe 12 to be extended between the first 18 and second 20 ends as shown in FIG. 5a. The pipe 12 is then through the receiving space and abutted against the covering 14. The covering 14 is rotated to cover the aperture 16. Once in position, adhesive 26 is used to adhere the covering 14 to the pipe 12 to prevent movement of the covering 14 with respect to the pipe 12. The adhesive 26 may positioned on the covering 14 or the pipe 12 before the covering 14 is placed on the pipe 12.

In use, the method is performed as described above and as shown in the Figures to cover the aperture 16 with the covering 14. The method provides a simple, effective and cost-saving means of repairing a leak 16 in a pipe 12 which does not require the removal and replacement of a section of the pipe 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A method of repairing a leak comprising the steps of:
positioning a covering on a pipe having an aperture therein and covering said aperture with said covering, said pipe having a tubular shape, said pipe being comprised of a plastic material, said pipe having circular cross-section, said covering comprising an annular member having a break therein such that a first end and a second end are defined, said covering being comprised of a resiliently bendable material.

2. The method according to claim 1, wherein said step of positioning a covering on a pipe further includes the steps of:
spacing apart said first and second ends to form a pipe receiving space between said first and second ends;
extending said pipe through said receiving space and abutting said covering on said pipe; and
rotating said covering to cover said aperture.

3. The method according to claim 1, further including the step of adhering said covering to said pipe with an adhesive to prevent movement of said covering with respect to said pipe.

4. A method of repairing a leak comprising the steps of:
positioning a covering on a pipe having an aperture therein and covering said aperture with said covering, said pipe having a tubular shape, said pipe being comprised of a plastic material, said pipe having circular cross-section, said covering comprising an annular member having a break therein such that a first end and a second end are defined, said covering being comprised of a resiliently bendable material, said step of positioning a covering on a pipe further including the steps of;
spacing apart said first and second ends to form a pipe receiving space between said first and second ends;
extending said pipe through said receiving space and abutting said covering on said pipe;
rotating said covering to cover said aperture;
adhering said covering to said pipe with an adhesive to prevent movement of said covering with respect to said pipe.

5. A fluid conduit and leak repairing combination system including:
a pipe having an aperture therein, said pipe having a tubular shape, said pipe being comprised of a plastic material, said pipe having circular cross-section;
a covering comprising an annular member having a break therein such that a first end and a second end are defined, said covering being comprised of a resiliently bendable material, said covering being configured to space said first and second ends apart to form a pipe receiving space, said pipe being extended through said pipe receiving space such that said covering abuts said covering and said covering is positioned over said aperture;
an adhesive adhering said covering to said pipe to prevent movement of said covering with respect to said pipe.
